(19) United States
(12) Patent Application Publication
(10) Pub. No.: US 2014/0175001 A1
(43) Pub. Date: Jun. 26, 2014

(54) AQUATIC REMEDIATION APPARATUS

(71) Applicant: Loren Eugene Willis, II, Vincennes, IN (US)

(72) Inventor: Loren Eugene Willis, II, Vincennes, IN (US)

(21) Appl. No.: 13/726,770

(22) Filed: Dec. 26, 2012

(51) Int. Cl. C02F 11/02

(52) U.S. Cl. CPC C02F 11/02
USPC 210/242.1

(57) ABSTRACT

A low power treatment device for the in-situ remediation of aquatic infrastructure is disclosed. Water is pumped up from the surface, directly, or indirectly trickled down through multiple elevated and cascaded stages containing bio-media, into the accumulation base of which is floating on the surface of a body of water. Clean water accumulated is automatically flushed released through a drain hose, aerating the bottom sediment, thereby biologically reducing, sludge buildup, pollution, and disrupting the stratified layers within the body of water with a minimal of turbidity. Water may be pumped up or flush released at any level within the body of water, thereby allowing the up and down skimming of surface for subsequent harvesting of surface vegetation and movement of water.

The present application is concerned with the remedial treatment of a body of water within an aquatic infrastructure that has a buildup of contaminated, decayable organic matter that is present on the bottom, or otherwise sludge on the bottom where upper stratum layer water is pumped by a small solar or wind powered pump located beneath the base of the floating grow house platform onto a top UN-leveled stage where the water is forced by gravity through consecutive alternately UN-leveled stages of bio media leaching into contained mycelium media or hydroponics plants located on top of said bio media for natural transfer conditioning and aerating the water before the water is collected in a reservoir at the floating base that is periodically, automatically, devised with low profile reservoirs containing counter weight offset pivots, and subsequent siphon to be flushed through a weighted flexible drain pipe down to the bottom stratum directly injecting into the occurring sedimentary sludge of the body of water causing an oxygen laden, clean water circulation with a slurry of aerobic, semi-aerobic, and anaerobic microorganisms that mechanically, ironically, biologically, irrigate, agitate, aerate to subsequently reduce the organic buildup and attempt to balance the stratified layers. Alternative applications for this float-able platform are inevitable.

### TECHNICAL FIELD AND INDUSTRIAL APPLICABILITY

This invention could be used in septic sludge conditions such as municipal waste management ponds, agricultural animal ponds, and neighborhood lakes. Primary intent is for environmental cleaning. Mushrooms can be grown because of the low light levels imposed by multiple stages with mycelium being an intricate part of the bio-filter process. Oil spills and chemical contamination can be cleaned up while water stratification can be reduced at the same time, without the need for grid power on location. A small amount of water accumulated and then suddenly dumped can be a powerful force. With the power of gravity and a sudden influx of water, a small solar powered pump can accumulate water and displace large areas of sludge at the bottom of a pond. The deeper the better but only a few feet are needed to allow a siphon flush of several gallons of clean, oxygenated, ambient temperature water, in multiple quick actions. The mechanism is as simple as a toilet flush and where a small teeter tottered type water trough is displaced and them dumped into an accumulated volume of water. Bio-filter and then toilet flush in a reverse septic system, together these old technologies create a new idea.

### BACKGROUND OF THE INVENTION

There has always been a large variety of methods for treating ponds that are considered to be unnatural and a high maintenance area where Lakes are often considered to be natural and low maintenance. The ponds which man has built must also be maintained by man to stay alive. They are more unnatural than natural. Lakes tend to have only positive impacts on their surrounding environments where as, over time, ponds do not, and can even produce negative effects.

Probably the largest drawback to treating a pond is the availability and cost of power. Many lakes or ponds do not have access to AC power to run the large air pumps for mixing stratified layers with oxygen. Fountains for this purpose require a considerable amount of expensive power to operate.

Every year millions of fish are killed when ponds cycle their stratified layers because of seasonal change. Simply because warm water rises and cool water sinks, oxygen levels can be depleted, pollution is sometimes released, and the natural environment suffers. Cool water has more oxygen than warm water unless it is winter and the water is frozen where a hole in the ice goes a long way with oxygen. Algae can flourish in the warm summer surface water and deplete oxygen from this warm water. A large, windswept pond in an open area rarely stratifies because of the continual mixing and usually does not experience problems associated with a premature turnover. The plants and organics can quickly deplete theoxygen in a shallow UN-stratified pond.

This invention offers a new and unique method of aiding or effectively speeding up the seasonal turn over in water bodies by injecting water from the upper stratum layer to the lower stratum layer thereby physically dislodging the sludge and sending oxygen and aerobic bacteria to where it is needed within an anaerobic layer to break down the sludge into usable properties. This can be accomplished with no outside grid power requirements and can in fact pay for its self in a short period of time, particularly with sponsorship and as an advertizing tool.

Fungi have demonstrated the ability to clean up the water runoff from farming, cattle ranches, and even breaking down oil spills. This invention not only injects but also cleans and conditions the water before it is released. Rain water runoff into a lake can carry oxygen depleting organics into the water. Europeans have used Barely straw in a burlap bag to ward off algae buildup. High powered air diffusers have been used to oxygenate and circulate water from the top to the bottom. Costly chemical clarification, bio filtration, and even aquaponics within a closed system uses plants to clean up fish waste.

Sludge at the bottom of ponds is the result of years of dead algae and suspended organic particles that have settled into an anaerobic or low oxygen area. This sludge exist there indefinitely if given the chance but often it will kill a pond in the end. A lively lake can turn into a shallow dead lagoon and can cost hundreds of thousands of dollars to pump and haul the sludge to restore the lake to its former glory. This can happen quickly or take hundreds of years. The sludge can accumulate harbored chemical poisons and heavy metals in a complicated molecular state of aqueous, no oxygen, humic suspension. With millions of drain ponds located on farms throughout the world, most are tied into an infrastructure of streams that take excess water to even larger ponds or rivers that usually end up in oceans. Containment is just a matter of time and how much rain, but the Humic acids that are a part of the sludge can attach and carry a hundred year worth of pollution with new rain water and a seasonal turnover.

Expensive digging or pumping leaves the question of where does contamination go from there. Soil type microbes, enzymes, and oxygen in the soil can break down the polluted humic molecules. Perhaps a better option is to break the pollution down at the source or in-situ of accumulation quickly, cheaply, and effectively making each polluted aqueous site a closed system. It is inevitable that pond sludge and the complicated humic molecules will need to be dealt with. It might be considered a ticking time bomb for our children's health and the ecological food web. Governments can not afford to clean every site by pumping or dredging. Unwanted floating Tussocks can be modified by breaking them loose from the bottom sludge and directing them out of the way of boat traffic and unwanted plant and animal life can be encouraged to go away.

Cost effective, simple and reliable this device can save fish from the oxygen starved spring and fall turnover normally associated with ponds by slowly doing the same thing throughout the entire year. This device can also reduce contamination and years of organic buildup in our aquatic environment that otherwise has had no chance for remediation.

### SUMMARY OF THE INVENTION

Reducing anaerobic sludge within a pond through solar powered bio-filtration and gravitational injection of clean aerobic water. This is accomplished with a small alternative powered water pump, floating platform with several layers of bio-filter, and flushing drain with hose.

### SPECIFICATION

### DETAILED DESCRIPTION AND PREFERRED EMBODIMENTS OF THE INVENTION

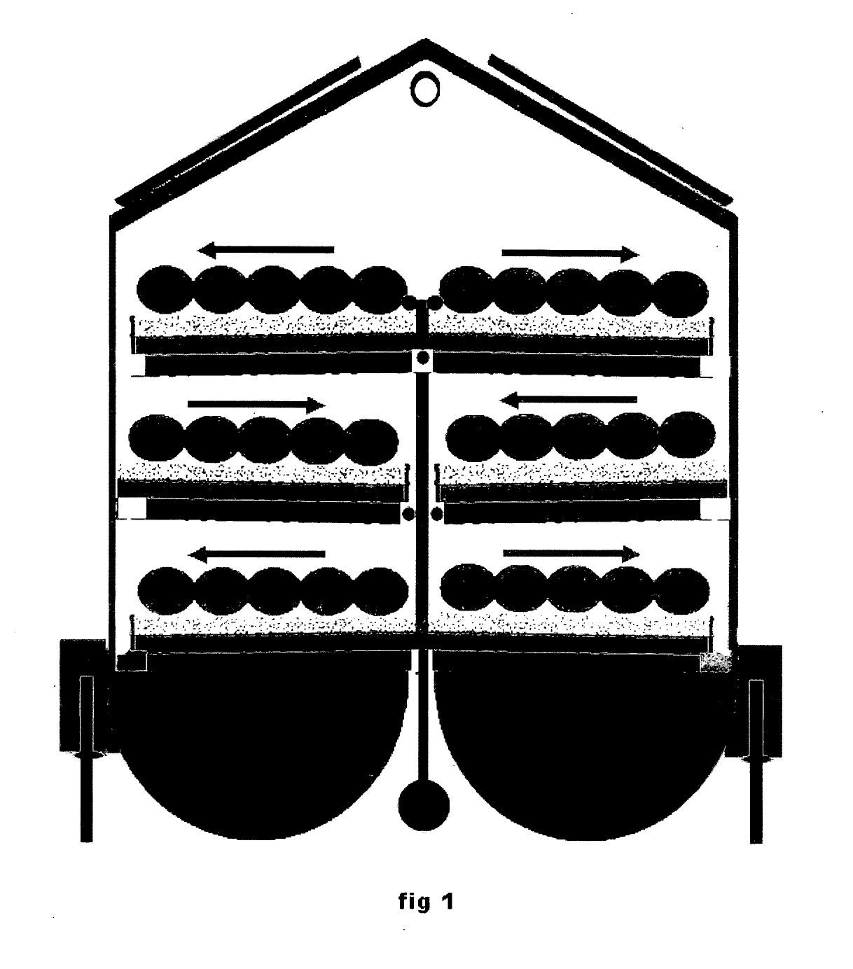

The conceptual design of the invention can be applied to any size of embodiment. The ideal size for the specific application of environmental remediation might be a standard 2 inch thick 4 foot by 4 foot sheet of Styrofoam floated by Styrofoam filled barrels, preferably cut in half. Multiple layers, maybe 2 or more, Styrofoam platforms can be framed with aluminum, wood, plastic, slightly tilted, and located directly above the base 4×4 sheet of Styrofoam. FIG. 1

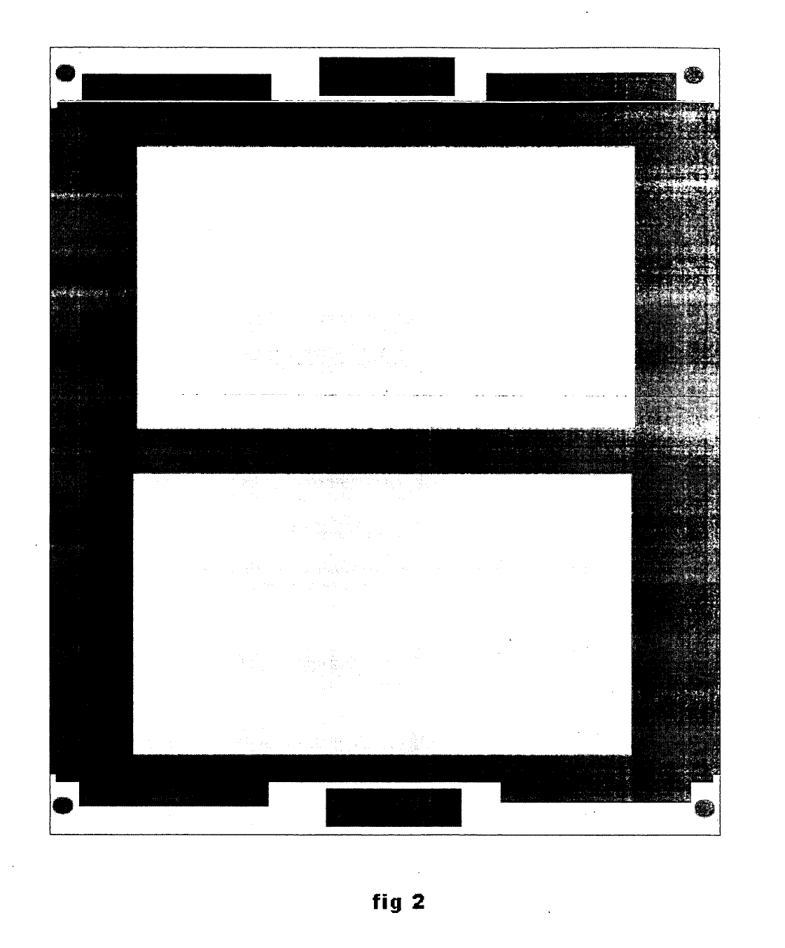

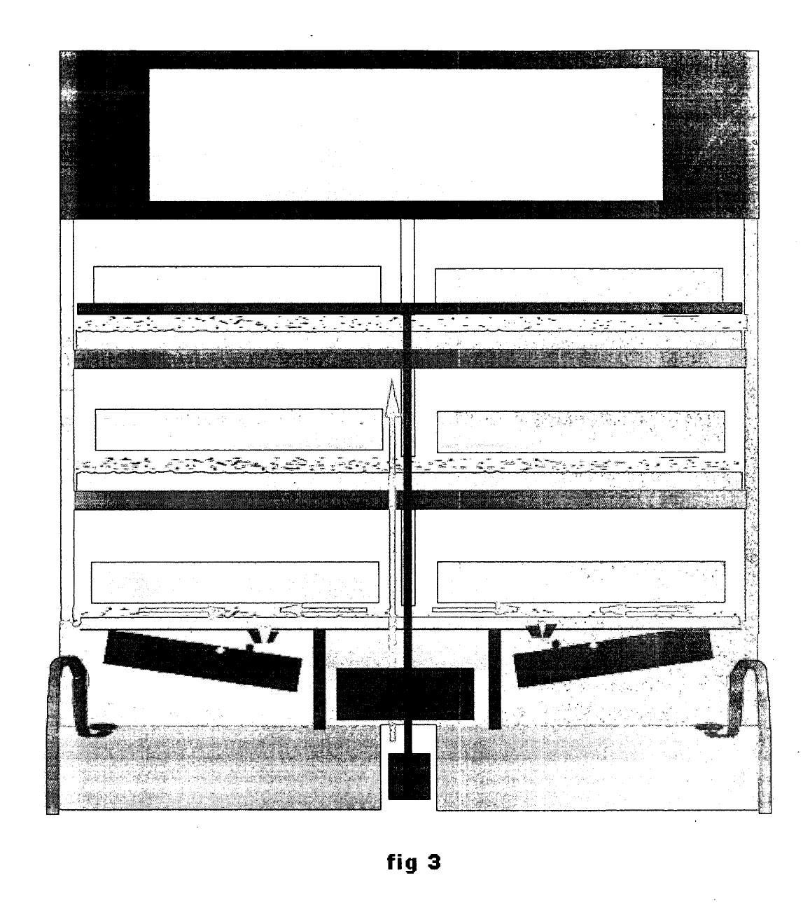

A small 1,200 or 2,400 gph mag drive pump, powered by solar power panels mounted on the roof, FIG. 2 would pump water from beneath the barrels near the surface and onto the top layer platform to allow a trickle down of water permeating a modular bed of light weight bio media with a large surface area interaction, accumulating at the lowest level. FIG. 3

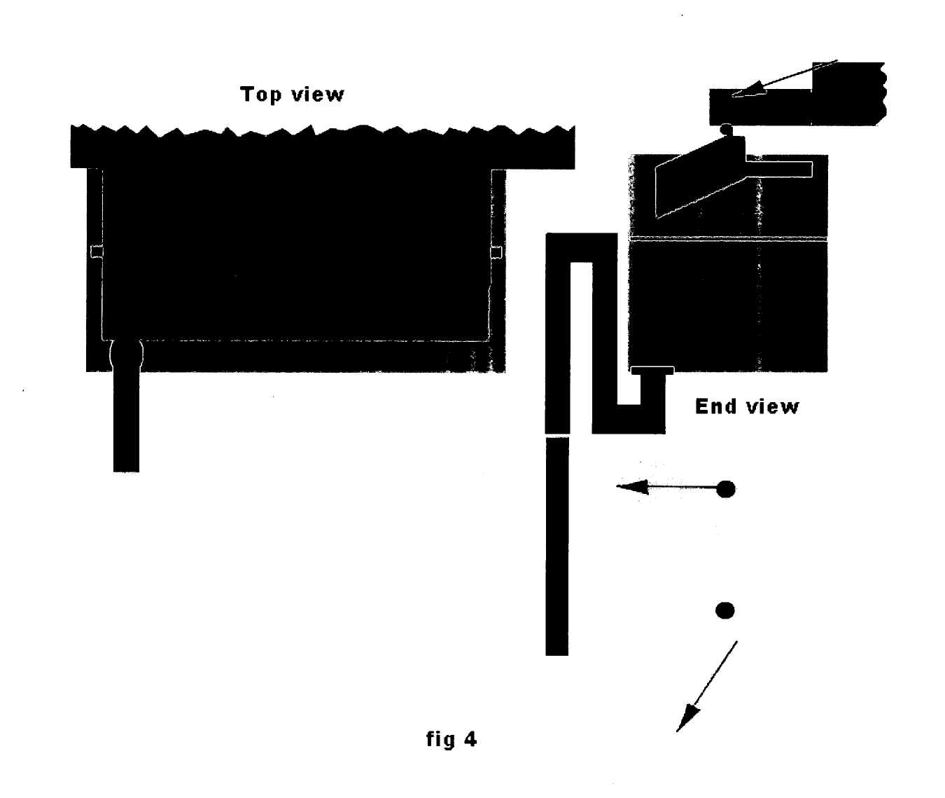

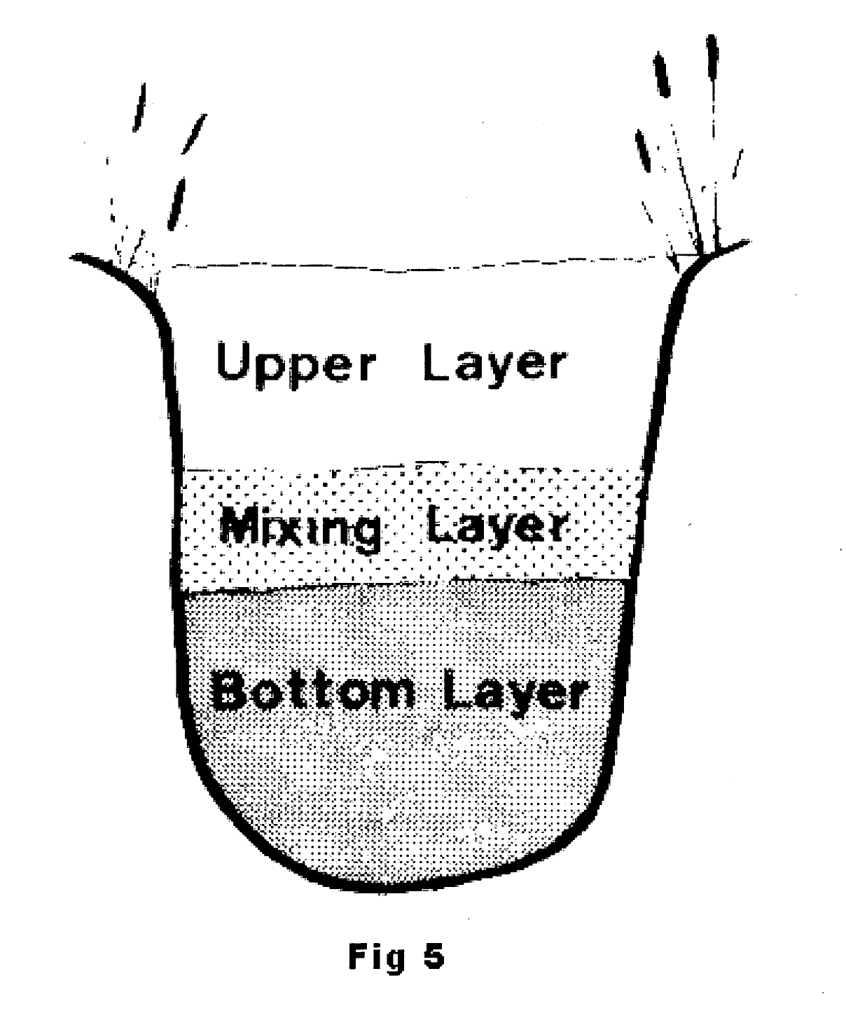

Multiple 4 gallon containers would fill to a point just above an S shaped pipe attached to the bottom of the container then automatically and continuously pulse flush with an offset tilt-able reservoir FIG. 4 sending the accumulated water back into the pond where it came from, FIG. 5 as is needed, by a weighted flexible 2 inch diameter hose.

The biology of said bio media should be enhanced with mycelium producing mushroom fungus contained within media filled porous plastic tubes laying on top of bio rocks. The embodiment structure should be enclosed with plastic insulation to allow the grow house to function properly with a containment of humidity and temperature.

### BRIEF DESCRIPTION OF THE FIGURES

(FIG. 1.) A side view—illustrates the narrower end view of the invention.

(FIG. 2.) A top view—illustrates the top view and associated solar panels on both sides of the top.

(FIG. 3.) A front view—illustrates the long side, front or back side of the invention.

(FIG. 4.) Drain—illustrates the automatic flushing drain mechanism from the top and side.

(FIG. 5.) Water body—demonstrates the stratification of pond layers.

1. An AQUATIC REMEDIATION APPARATUS: where water is pumped up to above a float-able platform, then cascaded through multiple bilaterally slanted platform shelf's each containing a layer of bio-media and collected in a reservoir at the base that is periodically automatically devised to be flushed through a drain hose.

2. An AQUATIC REMEDIATION APPARATUS: as in claim 1, where it is powered by solar cells, or wind generator, where a bio-media is composed of structured porous media to allow large surface area interaction, including and contained natural; rocks, plants, roots, mycelium fungus.

3. An AQUATIC REMEDIATION APPARATUS: as in claim 1, where it can be used for a large variety of alternative applications such as advertizing, and filtration, with mounting for any low powered device, or aquatic enhancements including, but not limited to: pond heater, water temperature stabilization, water level float for raising gate, direct transfer of filter water to streams, Predator scare, fish attraction, display, advertising, lights, solar power, wind power, wind break, monitoring telemetry, fish feeder, injector, spreader, decorations, fountain, air pump, alarm, flying insect zappers, UV light, heated hose, ultrasonic transducer for algae control.
